(19) United States
(12) Patent Application Publication
(10) Pub. No.: US 2013/0022840 A1
(43) Pub. Date: Jan. 24, 2013

(54) METHOD FOR MANUFACTURING A MAGNETIC WRITE HEAD WITH A FLOATING LEADING SHIELD

(71) Applicants: Wen-Chien D. Hsiao, San Jose, CA (US); Ning Shi, San Jose, CA (US); Yi Zheng, San Ramon, CA (US)

(72) Inventors: Wen-Chien D. Hsiao, San Jose, CA (US); Ning Shi, San Jose, CA (US); Yi Zheng, San Ramon, CA (US)

(73) Assignee: Hitachi Global Storage Technologies Netherlands B. V., Amsterdam (NL)

(21) Appl. No.: 13/187,355

(22) Filed: Jul. 20, 2011

(51) Int. Cl. G11B 5/33; C25D 5/02; B05D 5/12

(52) U.S. Cl. 428/815.2; 427/131; 205/119

(57) ABSTRACT

A method for manufacturing a magnetic write head having a write pole with a tapered leading edge formed on a substrate having a tapered surface and a wrap-around, trailing magnetic shield. The method uses a multi-layer anti-reflective coating prior to formation of the shield so that reflection from the tapered surface of the substrate does not affect the lithography of the mask used to form the trailing shield. The multi-layer antireflective coating is constructed of materials that can be left in the finished head, thereby eliminating problems associated with removal of the anti-reflective coating.

### FIELD OF THE INVENTION

The present invention relates to perpendicular magnetic recording and more particularly to a method for manufacturing a magnetic write head having a floating leading shield and well defines side shields. The method resulting in improved side shield throat height definition.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head can include a magnetic write pole and a magnetic return pole, the write pole having a much smaller cross section at the ABS than the return pole. The magnetic write pole and return pole are magnetically connected with one another at a region removed from the ABS. An electrically conductive write coil induces a magnetic flux through the write coil. This results in a magnetic write field being emitted toward the adjacent magnetic medium, the write field being substantially perpendicular to the surface of the medium (although it can be canted somewhat, such as by a trailing shield located near the write pole). The magnetic write field locally magnetizes the medium and then travels through the medium and returns to the write head at the location of the return pole where it is sufficiently spread out and weak that it does not erase previously recorded bits of data.

A magnetoresistive sensor such as a GMR or TMR sensor can be employed for sensing magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to maximize data density, it is necessary to minimize the track width of the data track written by the write head. In order to decrease the track width, it is necessary to minimize the width of the write pole itself. Unfortunately, limitations in manufacturing processes, such as reflective notching at very small dimensions, have limited the amount by which such write pole width can be minimized.

### SUMMARY OF THE INVENTION

The present invention provides a magnetic write head, comprising: a substrate having a tapered surface; a write pole having a leading edge and first and second sides, formed above the substrate such that the tapered surface of the substrate defines a corresponding tapered leading edge on the write pole; a non-magnetic side gap formed at each of the first and second sides of the write pole; a multi-layer antireflective coating formed over the non-magnetic side gap and the substrate; and a magnetic shield formed over the multi-layer antireflective coating.

The write head can be constructed by a method that includes, forming a substrate having a surface a portion of which is tapered; forming a magnetic write pole having a leading edge and first and second sides, and having a non-magnetic gap layer formed at the first and second sides and between the leading edge of the write pole and the substrate; depositing a multi-layer anti-reflective coating over the substrate; and forming a magnetic shield over the multi-layer anti-reflective coating.

The method uses a multi-layer anti-reflective coating prior to formation of the shield so that reflection from the tapered surface of the substrate does not affect the lithography of the mask used to form the trailing shield. The multi-layer antireflective coating is constructed of materials that can be left in the finished head, thereby eliminating problems associated with removal of the anti-reflective coating.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view of a magnetic head, taken from line 3-3 of FIG. 2 and rotated 90 degrees counterclockwise, of a magnetic head according to an embodiment of the present invention;

FIG. 4 is an ABS view of a portion of the read head of FIG. 3; and

FIGS. 5-22 are views in various intermediate stages of manufacture, illustrating a method of manufacturing a magnetic write head according to an embodiment of the invention.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

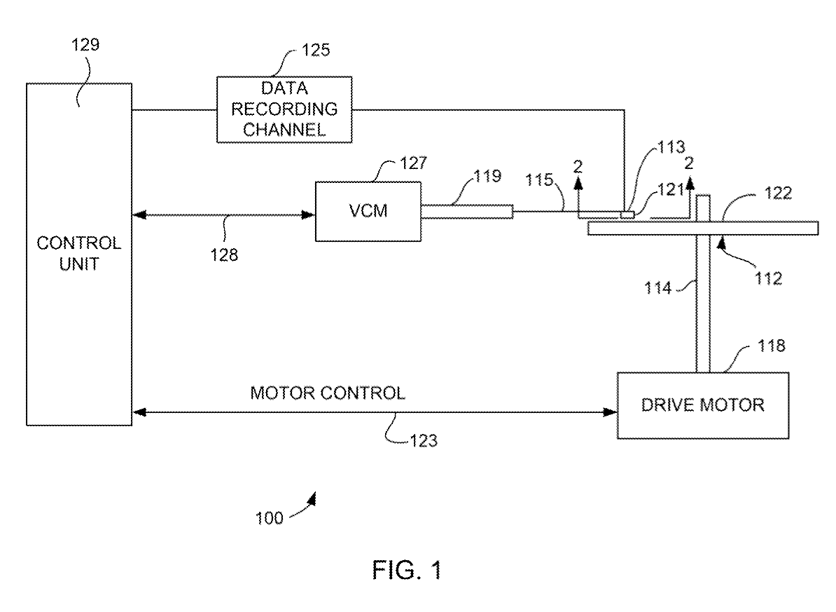

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

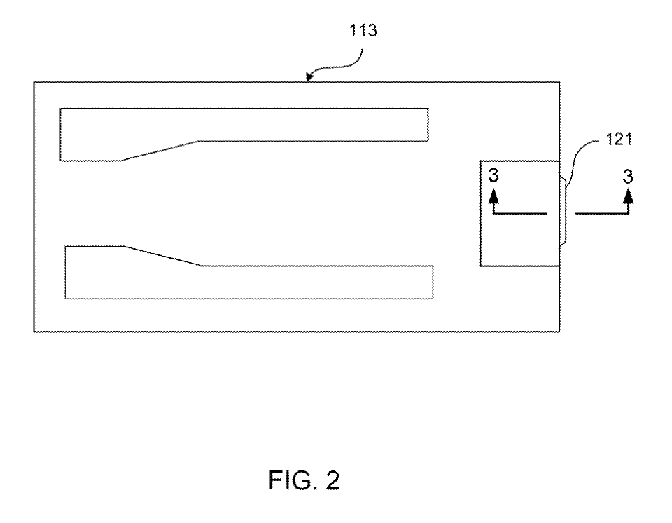

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

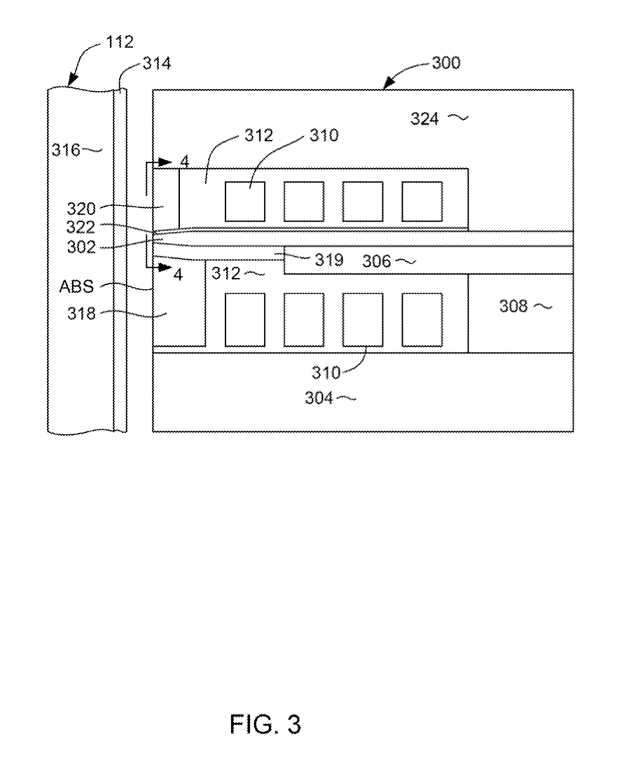

FIG. 3 is a side cross sectional view of a magnetic write head 300 that can be constructed by a method of the present invention. The write head 300 includes a magnetic write pole 302 and a magnetic return pole 304. The magnetic write pole 302 can be connected with a magnetic shaping layer 306 that helps to conduct magnetic flux to the tip of the write pole 302. The write pole 302 and shaping layer 306 can be connected with the magnetic return pole 304 by a magnetic back gap structure 308. A non-magnetic, electrically conductive write coil 310 passes between the return pole 304 and the write pole and shaping layer 302, 306, and may also pass above the write pole and shaping layer 302, 306. The write coil 310 can be encased in a non-magnetic, electrically insulating material 312, which can be a material such as alumina and/or hard baked photoresist. When an electrical current flows through the write coil 310 a magnetic field is induced around the coil 310 that results in a magnetic flux flowing through the return pole 304, back gap layer 308, shaping layer 306 and write pole 302. This results in a write field being emitted from the tip of the write pole 302. This strong, highly concentrated write field locally magnetizes a magnetic top layer 314 of the magnetic media 112. The magnetic field then travels through a soft magnetic under-layer 316 of the magnetic media before returning to the return pole 304, where it is sufficiently spread out and weak that it does not erase the previously recorded bit of data.

With continued reference to FIG. 3, a leading magnetic shield structure 318 is formed at the air bearing surface (ABS) to prevent magnetic field from the write coil 310 from inadvertently reaching the magnetic media 112. The leading shield 318 is separated from the leading edge of the write pole 302 by a non-magnetic layer 319 that will be described in greater detail herein below. In addition, the write head 300 may include a magnetic trailing shield 320 that is located at the ABS and which is separated from the write pole 302 by a thin, non-magnetic trailing gap layer 322. The trailing shield 320 may be magnetically connected with the back portion of the write head 300 by a trailing return pole 324.

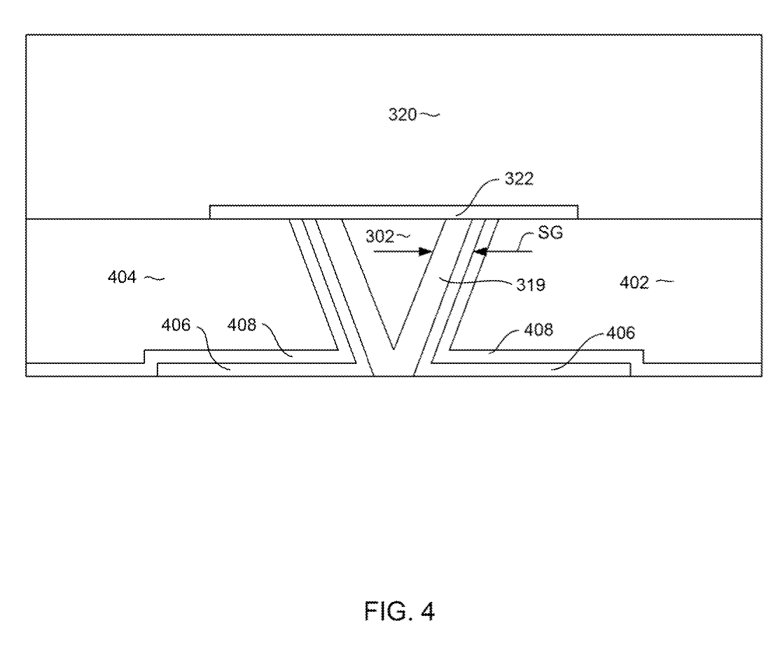

FIG. 4 shows an enlarged ABS view of a portion of the write head 300 as seen from line 4-4 of FIG. 3. As seen in FIG. 4, the write head 300 includes first and second magnetic side shields 402, 404, that are separated from the write by a non-magnetic side gap distance SG. The side gap distance SG can include a non-magnetic layer 319 that also functions as a leading gap layer and may be constructed of a non-magnetic metal such as Ru. The SC may also include a layer of non-magnetic material such as alumina 406 that is a bi-product of a manufacturing process that will described herein below. A layer 408 can be formed over the layer 406. This layer 408 is also a bi-product of a manufacturing process that will be described and is preferably constructed of a magnetic metal such as CoFe.

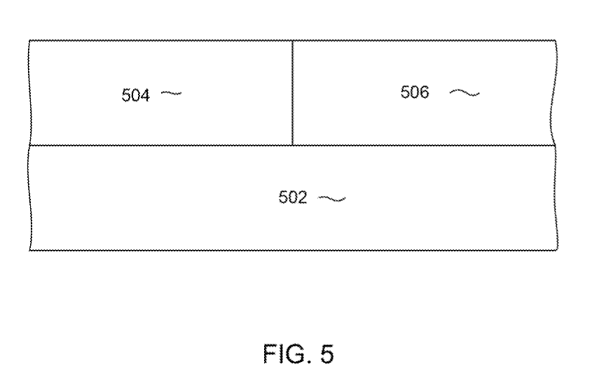

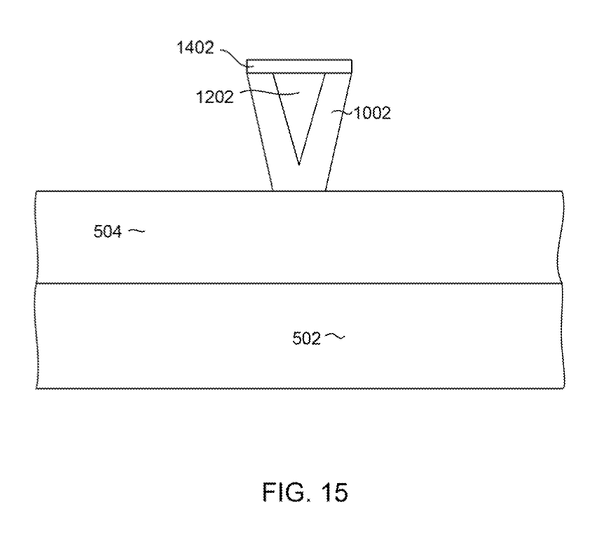

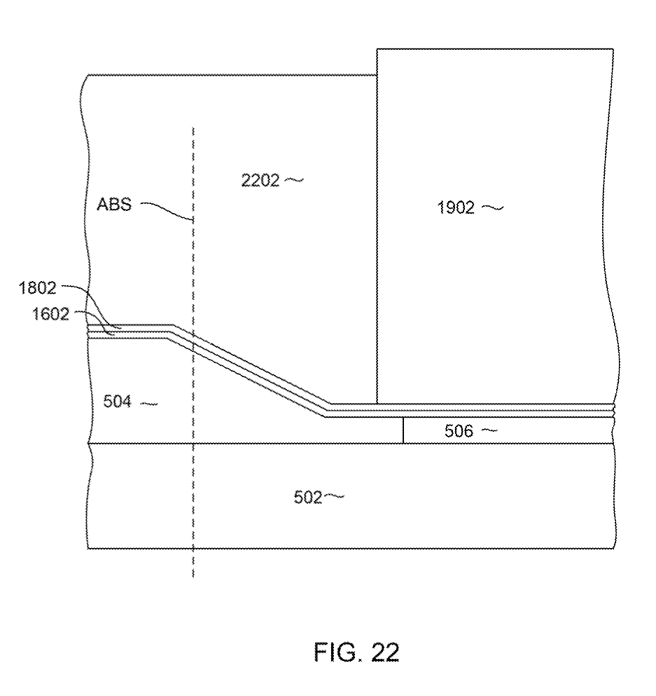

FIGS. 5-22 illustrate a method for manufacturing a magnetic write head according to an embodiment of the invention. With particular reference to FIG. 5, a substrate 502 is provided. The substrate can be a planar non-magnetic material such as alumina and can be or can include the non-magnetic fill layer 312 described above with reference to FIG. 3. A leading magnetic shield layer 504 and a non-magnetic fill 506 are formed over the substrate. The leading shield structure 504 and 506 together define a coplanar upper surface 508 that can be formed by chemical mechanical polishing. The structures 504, 506 can be formed by various processes including material deposition, photolithographic masking and material removal processes.

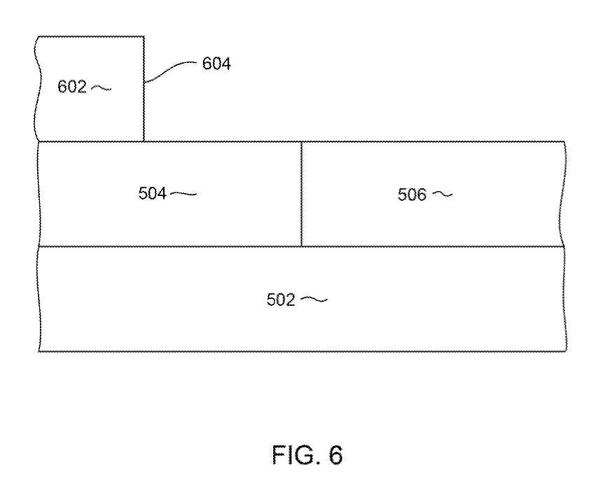

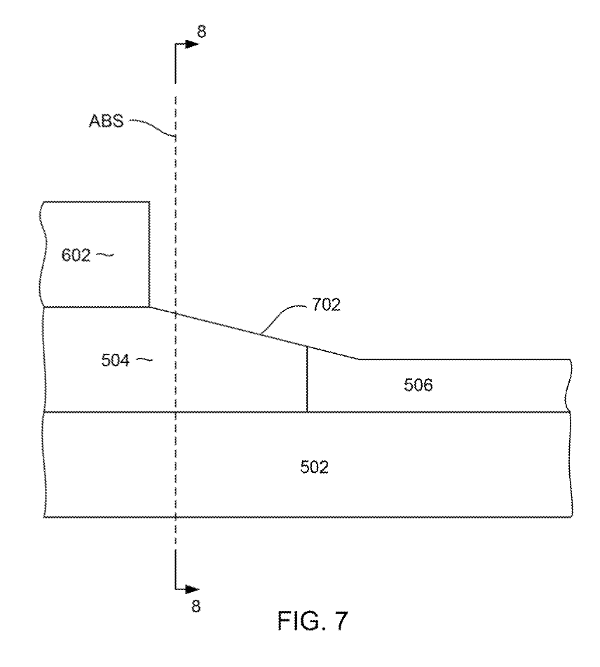

With reference now to FIG. 6, a mask 602 is formed over the leading shield structure 504. The mask 602 has a back edge 604 that is located so as to define an initiation point for a taper, as will become clearer below. An ion milling process is then performed to remove portions of the layers 504, 506 that are not protected by the mask 602. The ion milling is performed in such a manner and at such an angle that shadowing from the layer 602 causes the ion milling to form the layers 504, 506 with a tapered upper surface 702 as shown in FIG. 7. The angle and length of the tapered surface 702 can be controlled by the ion milling conditions and the height of the mask 602. In FIG. 7, the relative location of the air bearing surface plane is represented by the dashed line designated as “ABS”.

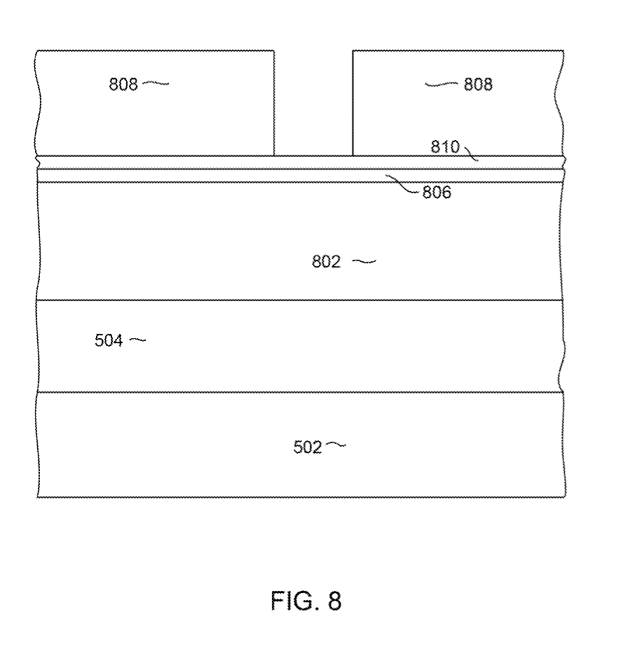

FIG. 8 shows a view of a cross section along a plane that is parallel with the air bearing surface (ABS) as seen from line 8-8 of FIG. 7. With reference to FIG. 8, a RIEable fill layer 802 is deposited to a thickness that is at least as high as a desired height of a write pole to be formed. The term RIEable as used herein means that the material 802 can be removed by a reactive ion etching (RIE) process. To this end, the layer 802 can be constructed of alumina.

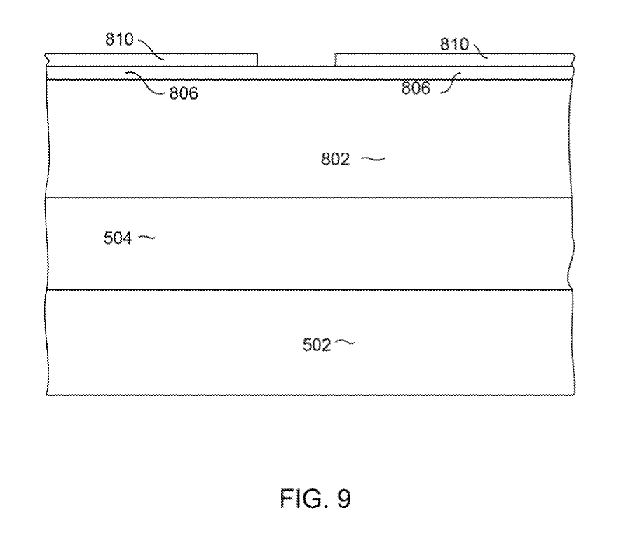

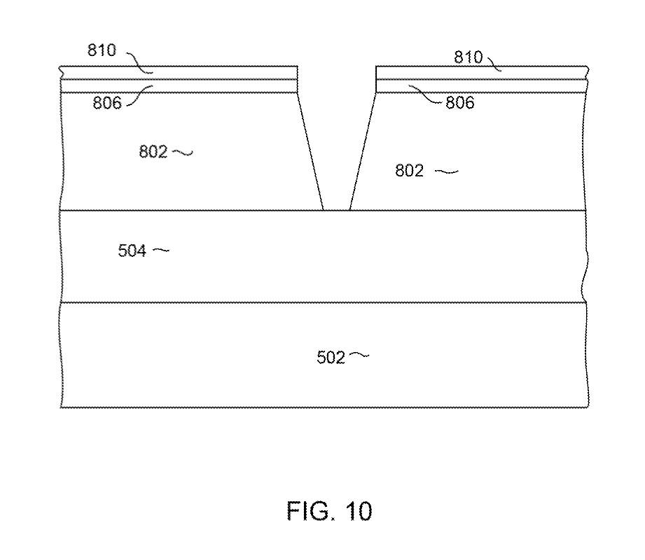

A spacer mask layer 806 can be deposited over layer 802. This layer 806 can be a material such as Ta. A hard mask layer 810 can be deposited over layer 806. This layer 810 can be a material such as NiCr. Then a bi-layer photoresist mask 808 with trench opening can be formed over layer 810. Ion milling can be performed to remove portion of layer 810 that is not protected by the bi-layer photo resist layer 808. After ion milling, a liftoff process can be performed to remove the bilayer photo resist 808, leaving a structure as shown in FIG. 9 with an opening formed in the layer 806. A series of reactive ion etching processes are then performed to remove portions of the layer 806 and fill layer 802 that are exposed through the opening in the mask 810. The reactive ion etching used to remove the fill layer 802 is performed in a chemistry and under conditions so as to form a trench having tapered side walls in the fill layer 802 as shown in FIG. 10.

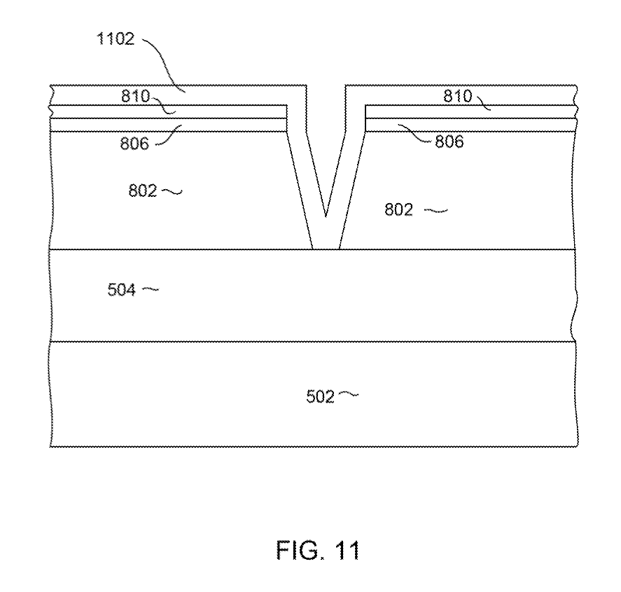

With reference now to FIG. 11, after the trench has been formed in the fill layer 802, a non-magnetic track-width reducing layer 1102 is deposited, preferably by a conformal deposition process such as atomic layer deposition. This layer 1102 is preferably constructed of Ru, although other materials could also be used. As can be seen, the layer 1102 reduces the width W of the trench, and also provides non-magnetic side walls.

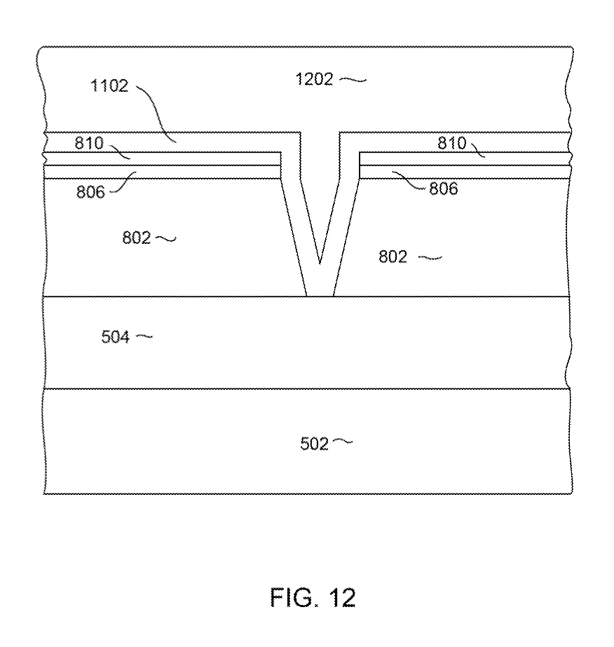

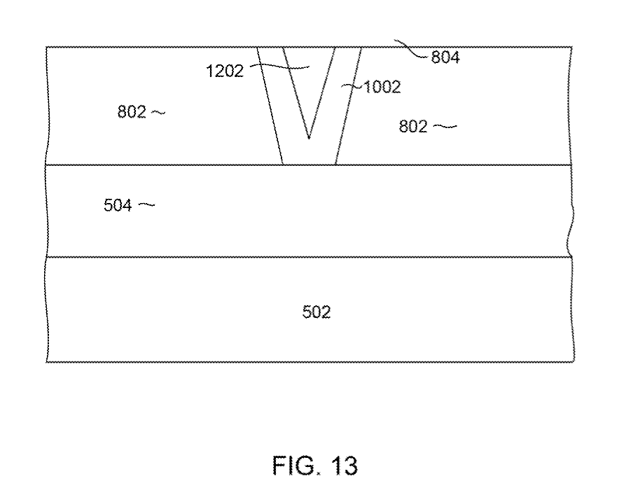

With reference to FIG. 12, after the layer 1102 has been deposited, a magnetic material 1202 such as Ni-Fe is deposited, preferably by electroplating to completely fill the trench formed in the fill layer 802 and layer 1102. Then, a combination of chemical mechanical polishing and ion milling are performed to remove layers 806, 810 and portions of layers 1102 and 1202 that extend outside of the trench, leaving a structure as shown in FIG. 13.

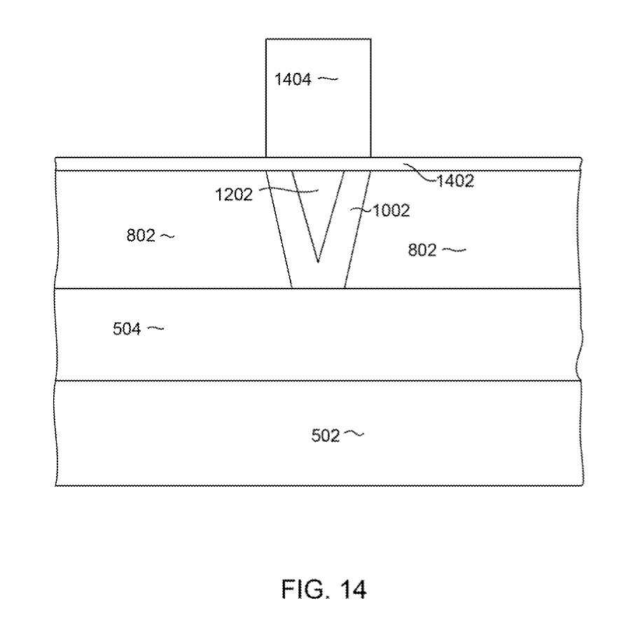

Then, a mask 1404 can be formed over the write pole 1202 and non-magnetic layer 1402, as shown in FIG. 14. An ion milling can then be performed to remove portions of the layer 1402 that are not protected by the mask 1404, thereby exposing the underlying fill material 802, and then a wet Al₂O₃ etch process can be performed to remove the fill material 802. The mask 1404 can then be lifted off.

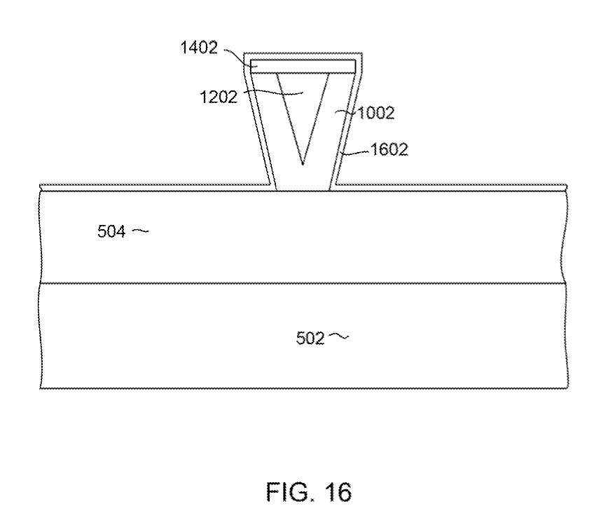

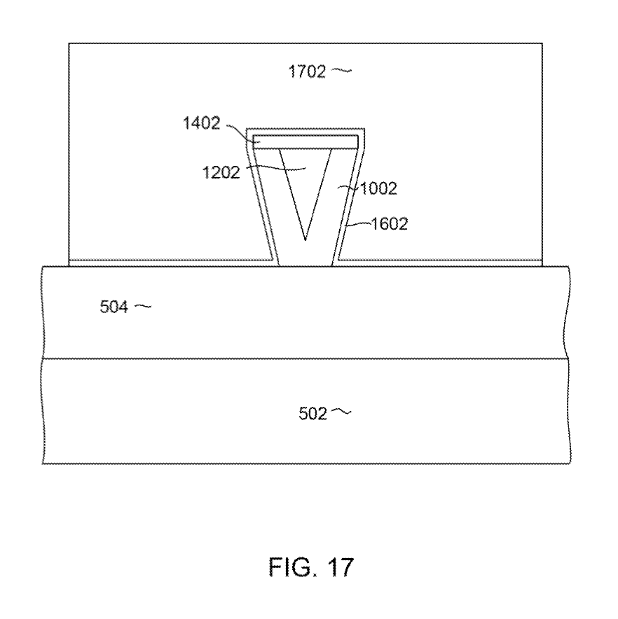

With reference now to FIG. 16 a first surface reflectance reducing seed layer 1602 is deposited. This layer 1602 is preferably alumina (Al₂O₃) and can also be constructed of TaₓO_{y}, SiₓO_{y}, SiₓO_{y}N_{z}, SiₓN_{y} or combinations of these materials. The layer 1602 is preferably deposited by a conformal deposition process such as atomic layer deposition, to a thickness of 20-30 nm or about 25 nm. Then, with reference to FIG. 17, in an optional step, a mask 1702 can be formed over the first seed layer so as to leave outer portions of the first seed layer 1602 exposed. A reactive ion etching can then be performed to remove exposed portions of the layer 1602, as shown in FIG. 17. The mask 1702 can then be removed.

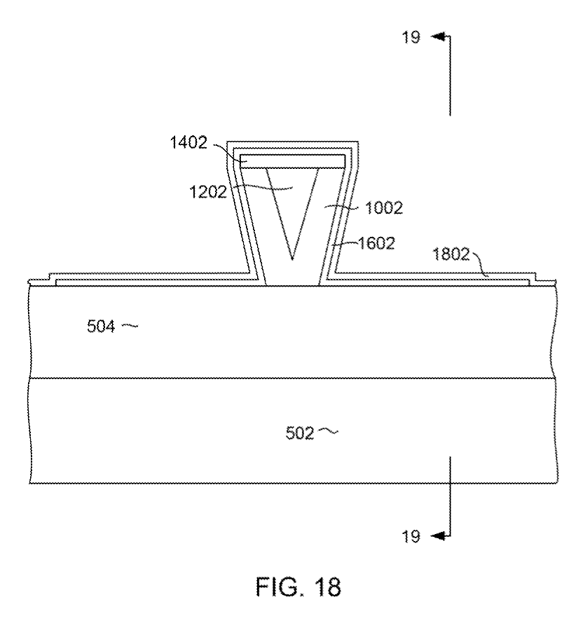

Then, with reference to FIG. 18, a second surface reflection reducing seed layer 1802 is deposited. This layer 1802 can be a material such as CoFe, CoNiFe, NiFe, Ru, Ir, Rh, NiCr, Ta or combinations of these materials and can be deposited to a thickness of 3-10 nm or more preferably about 5 nm. The function and purpose of these layers 1602, 1802 will be described in greater detail herein below.

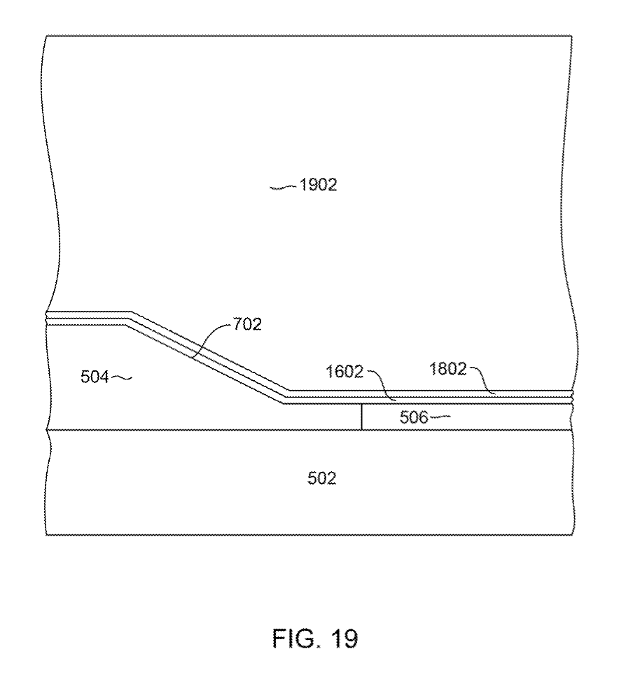

FIG. 19 shows a side cross sectional view as seen from line 19-19 of FIG. 18. It can be seen that the cross section of FIG. 19 is taken from an area at the side of, and removed from the write pole 1202 (as can be seen from the location of line 19-19 of FIG. 18). Therefore, FIG. 19 does not show the write pole 1202 or non-magnetic side wall material 1602. With reference to FIG. 19 a layer of photoresist material 1902 is deposited (spun on). This photoresist layer is sufficiently thick to form an electroplating frame mask for electroplating a magnetic side shield structure, as will become apparent below.

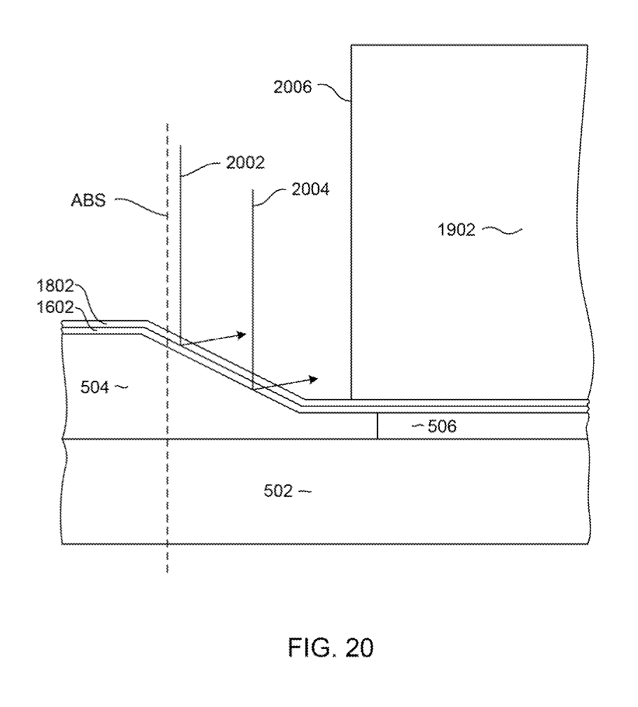

With reference now to FIG. 20, a photolithographic patterning process is performed to pattern and develop the photoresist layer 1902 to form a mask having an edge 2006 that is configured to define a back edge of a side shield structure. The throat height of the side shield 402, 404 (FIG. 4) is the thickness of the side shield as measured from the air bearing surface to the back edge in a direction that is perpendicular to the air bearing surface. This dimension is an important parameter to the performance of the write head, and the edge 2006 of the mask 1902 defines this back throat height of the side shields 402, 404 described above with reference to FIG. 4. Therefore, it is important that the edge 2006 of the mask 1902 be accurately defined.

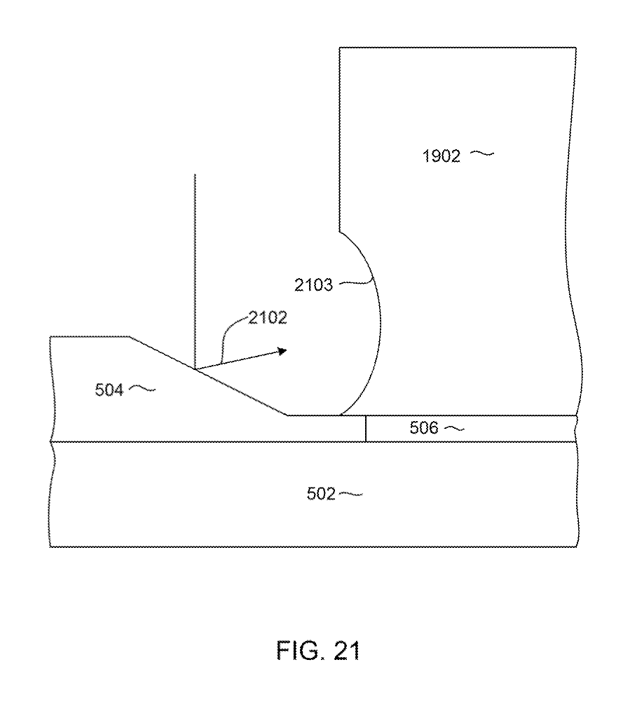

As can also be seen in FIG. 20, the underlying structure 504 includes the sloping or tapered surface 702 described above with reference to FIG. 7. This sloping edge 702 is left over from the process that allows the write pole 302 (FIG. 3) to have a desired tapered leading edge. The layers 1602, 1802 prevent reflection from the surface 702 from adversely affecting the photolithographic process used to define the mask 1902 as will be described below. FIG. 21 shows an example of the structure of FIG. 20, but without the layers 1602, 1802. As can be seen, during the photolithographic process used to define the mask 1902, a portion of the light used to pattern the mask 1902 reflects off of the tapered surface 702, as indicated by line 2102. This reflected light severely affects the photolighographic patterning of the mask 1902, causing a significant distortion of the edge of the mask 1902 as indicated by the curved deformation 2104.

While a standard bottom anti-reflective coating (BARC) such as DURMIMIDE® might be able to reduce this reflective notching 2104, the use of such a BARC layer would be problematic for a couple of reasons. Firstly, because of the nature of such materials, it would not be possible to evenly apply the material over all surfaces, especially on the sides of the write pole 1202 and nonmagnetic layer 1002 as shown, for example, in FIG. 18. This uneven application of the BARC layer would cause its own deformation during the photolithographic process. In addition, such materials are physically soft and cannot be left in the finished head. They must, therefore, be removed before continued processing of the head can be resumed. However, because of the sever topography of the structure (such as the overhanging feature of the write pole 1202 and non-magnetic side walls 1002 shown in FIG. 18) it would be difficult or impossible to remove all of the BARC layer in these areas. This would lead to serious problems in the finished head.

The present invention overcomes these problems by providing a multi-layer antireflective coating that can be evenly applied everywhere and that can also be left in the finished head without any adverse consequences, thereby eliminating any problem associated with the removal of the anti-reflective coating.

The multi-layer antireflective coating can include a first layer 1602 and a second layer 1802 formed over the first layer 1602. The first layer can be one or more of Al₂O₃, TaxOy, SixOy, SixOyNz or SixNy and can be 20-30 nm thick or about 25 nm thick. The second layer can be one or more of CoFe, CoNiFe, NiFE, Ru, Ir, Rh, NiCr or Ta and can be 3-10 nm thick or about 5 nm thick.

Alternatively, the multi-layer antireflective coating can be a tri-layer structure (not shown) that can include a first layer constructed of one or more of CoFe, CoNiFe, NiFe, Ru, Ir, Rh, NiCr or Ta; a second layer formed over the first layer and constructed of one or more of Al₂O₃, TaxOy, SixOy or SixNy; and a third layer formed over the second layer and constructed of one or more of CoFe, CoNiFe, NiFe, Ru, Ir, Rh, NiCr or Ta.

As shown in FIG. 20, during the photolithographic patterning of the mask 1902, a portion of the light will pass through the layer 1802 and reflect off of the layer 1602 as represented by arrow 2002, and a portion of the light will pass through both layers 1602, 1802 to be reflected off of the surface of layer 502 as indicated by arrow 2004. However, the thickness and material compositions of the layers 1602 and 1802 are selected such that the light portions 2002, 2004 reflected toward the mask 1902 180 degrees out of phase one another. Therefore, the net light reflected toward the mask 1902 will be zero or near zero. In this way, the mask 1902 can be formed with a straight, well defined wall 2006.

It should also be pointed out that the layer 1802 can be constructed of an electrically conductive material, such as the materials listed above. In this way, the layer 1802 can be used as an electroplating seed layer as well as an antireflective coating. After the mask 1902 has been defined as described above, a magnetic material 2202 can be electroplated to form a magnetic side shield structure, using the mask 1902 as an electroplating frame mask and using the layer 1802 as an electroplating seed layer. After the write head has been completed, the wafer on which it is formed can be sliced into rows of sliders, and a lapping operation can be performed to remove material until the dashed line ABS has been reached, thereby defining an air bearing surface (ABS).

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic write head, comprising:
a substrate having a tapered surface;
a write pole having a leading edge and first and second sides, formed above the substrate such that the tapered surface of the substrate defines a corresponding tapered leading edge on the write pole;
a non-magnetic side gap formed at each of the first and second sides of the write pole;
a multi-layer antireflective coating formed over the non-magnetic side gap and the substrate; and
a magnetic shield formed over the multi-layer antireflective coating.

2. The write head as in claim 1 wherein the multi-layer antireflective coating comprises a layer of alumina and a layer of CoFe formed over the layer of alumina.

3. The write head as in claim 1 wherein the multi-layer antireflective coating comprises a first layer and a second layer formed over the first layer, the first layer comprising one or more of Al₂O₃, TaxOy, SixOy, SixOyNz, SixNy, and the second layer comprising one or more of CoFe, CoNiFe, NiFe, Ru, Ir, Rh, NiCr or Ta.

4. The write head as in claim 1 wherein the multi-layer antireflective coating comprises a first layer, a second layer formed over the first layer and a third layer formed over the second layer; wherein the first layer comprises CoFe;
the second layer comprises Al₂O₃; and
the third layer comprises CoFe.

5. The write head as in claim 1, wherein the multi-layer antireflective coating comprises a first layer, as second layer formed over the first layer and a third layer formed over the second layer; wherein
the first layer comprises one or more of CoFe, CoNiFe, NiFe, Ru, Ir, Rh, NiCr or Ta;
the second layer comprises one or more of Al2O3, TaxOy, SixOy, SixOyNz or SixNy; and
the third layer comprises one or more of CoFe, CoNiFe, NiFe, Ru, Ir, Rh, NiCr or Ta.

6. The write head as in claim 1 wherein the multi-layer antireflective coating comprises a layer of alumina having a thickness of 20-30 nm and a layer of CoFe having a thickness of 3-10 nm formed over the layer of alumina.

7. The write head as in claim 1 wherein the multi-layer antireflective coating comprises a layer of alumina having a thickness of about 25 nm and a layer of CoFe having a thickness of about 5 nm formed over the layer of alumina.

8. The write head as in claim 1 wherein the multi-layer antireflective coating comprises a first layer and a second layer formed over the first layer, the first layer having a thickness of 20-30 nm and comprising one or more of Al₂O₃, TaxOy, SixOy, SixOyNz, SixNy, and the second layer having a thickness of 3-10 nm and comprising one or more of CoFe, CoNiFe, NiFe, Ru, Ir, Rh, NiCr or Ta.

9. The write head as in claim 1 wherein the multi-layer antireflective coating comprises a first layer and a second layer formed over the first layer, the first layer having a thickness of about 25 nm and comprising one or more of Al₂O₃, TaxOy, SixOy, SixOyNz, SixNy, and the second layer having a thickness of about 5 nm and comprising one or more of CoFe, CoNiFe, NiFe, Ru, Ir, Rh, NiCr or Ta.

10. The write head as in claim 1 wherein the non-magnetic side gap material extends between the leading edge of the write pole and the substrate.

11. A method for manufacturing a magnetic write head, comprising:
forming a substrate having a surface a portion of which is tapered;
forming a magnetic write pole having a leading edge and first and second sides, and having a non-magnetic gap layer formed at the first and second sides and between the leading edge of the write pole and the substrate;
depositing a multi-layer anti-reflective coating over the substrate; and
forming a magnetic shield over the multi-layer anti-reflective coating.

12. The method as in claim 11 wherein the forming a magnetic shield further comprises depositing a photoresist layer, lithographically patterning the photoresist layer to form an electroplating frame mask with an opening configured to define the magnetic shield, and electroplating a magnetic material into the opening to form the magnetic shield.

13. The method as in claim 12, wherein the multi-layer antireflective coating comprises first and second layers, the material composition and thickness of the first and second layers being selected such that a first portion of light used in the lithographic patterning passes through both of the first and second layers before being reflected back and a second portion of the light from the lithographic process passes through only one of the first and second layers before being reflected back, and wherein the first and second portions of light being out of phase with one another upon being reflected back.

14. The method as in claim 11 wherein the deposition of the multi-layer antireflective coating comprises first depositing a layer comprising Al₂O₃ and then depositing a layer of CoFe.

15. The method as in claim 11 wherein the deposition of the multi-layer antireflective coating comprises first depositing a layer comprising Al₂O₃ to a thickness of 20-30 nm and then depositing a layer of CoFe to a thickness of 3-10 nm.

16. The method as in claim 11 wherein the deposition of the multi-layer antireflective coating comprises first depositing a layer comprising Al₂O₃ to a thickness of 20-30 nm and then depositing a layer of CoFe to a thickness of 3-10 nm.

17. The method as in claim 11 wherein the deposition of the multi-layer antireflective coating comprises first depositing a layer comprising Al₂O₃ to a thickness of about 25 nm and then depositing a layer of CoFe to a thickness of about 5 nm.

18. The method as in claim 11 wherein the deposition of the multi-layer antireflective coating comprises first depositing a layer comprising one or more of Al2O3, TaxOy, SixOy, SixOyNz or SixNy, and then depositing a layer comprising one or more of CoFe, CoNiFe, NiFe, Ru, Ir, Rh, NiCr or Ta.

19. The method as in claim 11 wherein the deposition of the multi-layer antireflective coating comprises first depositing a layer comprising one or more of Al2O3, TaxOy, SixOy, SixOyNz or SixNy to a thickness of 20-30 nm, and then depositing a layer comprising one or more of CoFe, CoNiFe, NiFe, Ru, Ir, Rh, NiCr or Ta to a thickness of 3-10 nm.

20. The method as in claim 11 wherein the deposition of the multi-layer antireflective coating comprises first depositing a layer comprising one or more of Al₂O₃, TaxOy, SixOy, SixOyNz or SixNy to a thickness of about 25 nm, and then depositing a layer comprising one or more of CoFe, CoNiFe, NiFe, Ru, Ir, Rh, NiCr or Ta to a thickness of about 5 nm.

21. The method as in claim 1, wherein the deposition of the multi-layer antireflective coating comprises first depositing a layer comprising one or more of CoFe, CoNiFe, NiFe, Ru, Ir, Rh, NiCr or Ta, then depositing a layer comprising one or more of Al₂O₃, TaxOy, SiXOy, SixOyNz or SixNy and then depositing a layer comprising one or more of CoFe, CoNiFe, NiFe, Ru, Ir, Rh, NiCr or Ta.
